(19) United States
(12) Patent Application Publication
(10) Pub. No.: US 2022/0406065 A1
(43) Pub. Date: Dec. 22, 2022

(54) TRACKING SYSTEM CAPABLE OF TRACKING A MOVEMENT PATH OF AN OBJECT

(71) Applicants: Taehoon KANG, Gyeonggi-do (KR); VECTORSIS INC., Yongin-si, Gyeonggi-do (KR)

(72) Inventor: Taehoon KANG, Gyeonggi-do (KR)

(21) Appl. No.: 17/777,007

(22) PCT Filed: Nov. 13, 2019
(86) PCT No.: PCT/KR2019/015453

§ 371 Date: May 13, 2022

(30) Foreign Application Priority Data
Nov. 13, 2019 (KR) 10-2019-0144780

(51) Int. Cl. G06V 20/52; G06T 7/292

(52) U.S. Cl. CPC G06V 20/52; G06T 7/292; G06T 2207/30196

(57) ABSTRACT

Provided is a tracking system capable of tracking movement of an object existing in a photographed image, and more particularly, a tracking system capable of automatically photographing an intruder and continuously tracking an intruder when an intruder occurs in a surveillance area. =To this end, a plurality of image photographing units photographing and acquiring image information, an object extracting unit analyzing the image information transmitted from the image photographing unit by an image recognition program, comparing and analyzing the object information. According to the present invention, the movement path of the object entering the monitoring area may be determined, and even if the object enters the blind spot outside the monitoring area, the movement path in the blind spot may be determined through image analysis of the monitoring area adjacent to the blind spot.

### BACKGROUND

The present invention relates to a tracking system capable of tracking movement of an object existing in a photographed image, and more particularly, to a tracking system capable of automatically photographing an intruder and continuously tracking an intruder when an intruder occurs in a surveillance area.

As the importance of security increases, places where security systems using surveillance cameras are installed are increasing. However, the conventional security system independently photographed the area or part in charge of each surveillance camera, and stored and analyzed the image in the security system.

Therefore, even if multiple surveillance cameras monitor a specific area, the networking function between each surveillance camera was insufficient, so the association between images captured from each surveillance camera and the movement path of the same object depended on the manual work of the manager managing the security system.

Recently, a network camera has been used to automatically identify the movement path of the same object. Such a network camera is an IP camera connected by LAN line or Wi-Fi, and a PTZ camera (or a Pantilt camera) that tracks an intruder by rotating and zooming in real time is used.

In addition, network cameras are installed inside large buildings such as research institutes and public institutions, or inside small buildings such as homes, convenience stores, and banks, and can analyze images output from network cameras to monitor where network cameras are installed in real time or later identify external intruders.

Network cameras used in such security systems even provide the ability to detect and track intruders, but there is a limit to determining where the intruder is when the intruder is out of the view area. In detail, the conventional technology for location tracking is often installed in a fixed structure, and even when the wireless recognition device is installed in the mobile body, location tracking is performed using a radio frequency identification (FID) card or the like, or communicates with a central management unit to track the location of the mobile body. That is, real-time location tracking is possible only when a device that wirelessly communicates with the central management unit is installed on the mobile body. In addition, in the case of a dispatch system for arrest, a system in which a network camera or a surveillance sensor contacts a security company after detecting an intruder is generally used.

In other words, in the prior art, the location tracking method may accurately track the location through an RFID or a portable terminal, but this is limited to a visitor or device whose location is already approved. And the security system should be able to monitor and track unauthorized intruders, but not in the existing way. In addition, location tracking is not possible even if the device is lost by an approved visitor.

In addition, network cameras cannot track objects further when they are out of the surveillance zone, and cannot track the direction and path of movement afterwards.

In addition, when the intruder's movement is active, since it appears irregularly in various monitoring devices, a problem of missing the intruder from view may occur.

In addition, since the screen of the network camera is arranged flat, it is difficult to identify the intruder's movement and escape routes.

Accordingly, even if an intruder is found by a network camera or a surveillance sensor and contacted by a security company, the intruder is likely to escape during the dispatch time, and the location of the security company is inevitably moved around the location of the network camera or sensor. Therefore, there is a disadvantage that it is difficult to blacken or arrest intruders.

### SUMMARY OF THE INVENTION

Accordingly, an object of the present invention is to provide a tracking system capable of easily distinguishing only objects moving in a monitoring area through an image capturing a plurality of monitoring areas and tracking a movement path of an object passing through a blind spot through the classification of the objects.

In order to achieve the object of the present disclosure, the first embodiment of the present disclosure provides A tracking system capable of tracking a movement path of an object, the system comprising: a plurality of image photographing units for acquiring image information by photographing a surveillance area; an object extraction unit for generating object information, to which coordinates and photographing time of a moving object are added, by analyzing image information transmitted from the image photographing units using an image recognition program; and an object tracking unit for selecting object information including the same object image by comparing and analyzing images of each object through the object information, and tracking a movement path of the object by analyzing coordinates and photographing time of the selected object information.

In order to achieve the object of the present disclosure, the second embodiment of the present disclosure provides A tracking system capable of tracking a movement path of an object, the system comprising: a plurality of image photographing units for acquiring image information by photographing a surveillance area; an image storage unit for storing image information transmitted from each image photographing unit, and storing a 2D or 3D drawing of a space in which the plurality of image photographing units is installed; an object extraction unit for generating object information, to which coordinates and photographing time of a moving object are added, by analyzing the image information stored in the image storage unit using an image recognition program; an image output unit for outputting image information provided from each image photographing unit as an image; and an object tracking unit for extracting object information including the same object image from the image storage unit by analyzing an object image of an object selected as a selection signal of an object included in the image output through the image output unit is received, and displaying a movement path of the object on the drawing by analyzing coordinates and photographing time of the extracted object information.

In order to achieve the object of the present disclosure, the third embodiment of the present disclosure provides A tracking system capable of tracking a movement path of an object, the system comprising: a plurality of image photographing units for acquiring image information, to which surveillance area location information is added, by photographing a surveillance area; an object extraction unit for generating object information, to which coordinates and photographing time of a moving object are added, by analyzing the image information using an image recognition program; an object tracking unit for selecting object information including the same object image by comparing and analyzing images of each object through the object information, and tracking a movement path of the object by analyzing coordinates and photographing time of the selected object information; a user terminal including an augmented reality app installed therein, for generating structure image information, to which structure location information adjacent to the surveillance area location information is added, transmitting the structure location information to the outside through a communication network, receiving image information of a surveillance area adjacent to the structure location information, and outputting the image information so as to be overlapped with the structure image information; and an augmented reality unit for searching for location information of a first surveillance area that matches the structure location information transmitted from the user terminal and detecting image information of a surveillance area to which the first surveillance area location information is added, and transmitting the detected image information to the user terminal through a communication network.

According to the present invention, a plurality of image photographing units of each surveillance area may be connected to a communication network to identify a movement path of an object entering the surveillance area, and even when the object enters a blind spot, a movement path in the blind spot may be identified.

In addition, the present invention may easily track a movement path of an object by using an outline of an object that may be extracted from a surveillance image even if the object entering the surveillance area does not have an identification device such as a sensor.

In addition, the present invention may easily obtain the type and number of the object entering the monitoring area through analysis of the outline of the object entering the monitoring area.

In addition, the present invention may easily perform tracking by displaying a movement path and an expected escape path of an object entering the monitoring area on a 2D or 3D drawing, and may analyze an intrusion process because a movement of the object is displayed on a 2D or 3D drawing.

### BRIEF DESCRIPTION OF DRAWINGS

FIG. 1 is a block diagram illustrating a tracking system according to an embodiment of the present invention.

FIG. 2 is an embodiment of an outline photograph of an object displayed in an image output through a tracking system according to the present invention.

FIG. 3 is another embodiment of an outline photograph of an object displayed in an image output through a tracking system according to the present invention.

FIGS. 4 and 5 are exemplary diagrams illustrating an image of an object output through a tracking system according to the present invention.

FIG. 6 is a block diagram illustrating a tracking system according to another embodiment of the present invention.

FIG. 7 is a plan view illustrating a structure in which a user terminal is located according to the present invention.

FIGS. 8 and 9 are screens illustrating a screen output through a user terminal according to the present invention.

### DETAILED DESCRIPTION OF THE INVENTION

Hereinafter, a tracking system (hereinafter, referred to as an “object tracking system”) capable of tracking a movement path of an object according to preferred embodiments of the present invention will be described in detail with reference to the accompanying drawings.

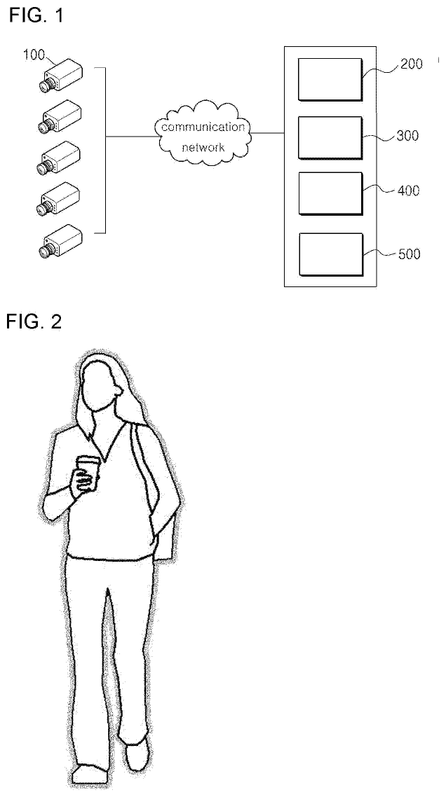

FIG. 1 is a block diagram illustrating an object tracking system according to an embodiment of the present invention.

Referring to FIG. 1, the object tracking system according to the present invention may include a plurality of image photographing units 100 for obtaining image information on a monitoring area, an image storing unit 200 for storing image information provided by each of the image photographing units 100, an object extracting unit 300 for outputting image information.

The image photographing unit 100, the image storage unit 200, the object extraction unit 300, the object tracking unit 400, and the image output unit 500 may be independently installed, or all of them may be installed to be embedded in a smartphone or a camera. In addition, the image storage unit 200, the object extraction unit 300, the object tracking unit 400, and the image output unit 500 may be connected to each other through wired or short-range wireless communication.

Let the image capturing unit 100 be referred to as \hat{1}, the image storage unit 200 as \hat{2}, the object extraction unit 300 as \hat{3}, the image output unit 500 as \hat{5}, and the object tracking unit 400 as \hat{4}. In this case, if necessary, the \hat{1}+\hat{2} or \hat{1}+\hat{2}+\hat{3} or \hat{1}+\hat{2}+\hat{3}+\hat{4} may be mounted with the functions of all devices embedded in the CCTV camera or the IP camera. In addition, \hat{2}+\hat{3} or \hat{2}+\hat{3}+\hat{4} can be equipped with the functions of all devices in a single PC or server. In addition, \hat{1}+\hat{2}+\hat{3}+\hat{4}+\hat{5} can be installed by integrating all devices into a black box or a smartphone with a display device attached.

Hereinafter, each component will be described in more detail with reference to the drawings.

Referring to FIG. 1, the object tracking system according to the present invention includes a plurality of image photographing units 100.

The image photographing unit 100 may be installed in a space to be monitored to photograph a predetermined monitoring area and obtain image information, and may generate image information to which an identification symbol is assigned to confirm the source of the image information.

The image photographing unit 100 independently photographs a monitoring area designated as a core area among the entire management area to generate image information on the monitoring area.

In addition, the image photographing unit 100 may transmit the generated image information to any one or more of the image storage unit 200, the object extraction unit 300, and the image output unit 500 through a wired/wireless communication network (hereinafter, abbreviated as “communication network”).

In addition, the image photographing unit 100 may acquire image information to which the location information of the monitoring area is added by photographing the monitoring area.

The image photographing unit 100 may use any camera as long as the monitoring area may be photographed. For example, a CCTV camera, an IP camera having an IP address, or a smartphone may be used as the image photographing unit 100.

As a specific aspect, the image photographing unit 100 according to the present invention uses a pan/tilt module and a pan tilt zoom (PTZ) camera embedded with a zoom module to continuously track and photograph an object, and preferably uses a speed dome camera. In this case, the image photographing unit 100 may use a PTZ coordinate value. Here, the PTZ coordinate value refers to a coordinate value based on three elements: fan, tilt, and zoom.

This fan coordinate value is a coordinate for left and right rotation on a horizontal axis, and generally has a coordinate value of 0 to 360°. And the tilt coordinate value is a coordinate for rotation back and forth on the vertical axis, and generally has a coordinate value of 0 to 360°. Finally, the zoom coordinate value is for photographing an object by optically enlarging it, and may be enlarged to several tens of times according to the performance of the image photographing unit 100.

In addition, the zoom coordinate value divides the screen into a predetermined size and sets a zoom magnification for each part in advance, so that when an object is captured in a part farthest from the photographing direction of the image photographing unit 100, the zoom of the camera is reduced. In this case, a preset zoom magnification may be changed according to a place and a situation where the image photographing unit 100 is installed.

Meanwhile, when the object is a vehicle, the image photographing unit 100 may photograph an enlarged image of the vehicle so that the license plate of the vehicle may be recognized, and when the object is a person, the enlarged image of the person may be recognized.

If necessary, the image photographing unit 100 may include a depth camera.

Also, the image photographing unit 100 may be created in a drone. The image photographing unit 100 photographs an object that enters the monitoring area while moving by a drone to generate image information. Then, the image photographing unit 100 mounted on the drone may generate image information on the object while following the object.

Referring to FIG. 1, the object tracking system according to the present invention may further include an image storage unit 200.

The image storage unit 200 is connected to each image photographing unit 100 through a communication network and stores image information transmitted from the image photographing unit 100. If necessary, the image storage unit 200 may store a 2D drawing or a 3D drawing of a space in which a plurality of image photographing units 100 are installed.

The image storage unit 200 may use a digital video recorder (DVR) or network video recorder (NVR)-based server, a personal computer (PC) equipped with a high-capacity hard disk drive (HDD), or a MICRO SD mounted on a smartphone or camera.

In addition, the image storage unit 200 includes a flash memory type, a hard disk type, a multimedia card micro type, a card type memory (e.g., XD memory, RAM), a static random access memory (SRAM), a programmable memory (REP), a magnetic memory (ROM), a memory (REP-ROM) Any one of a device disk and an optical disk may be used.

Specifically, the image storage unit 200 includes an image information database DB in which image information transmitted from the image photographing unit 100 is stored, a drawing database DB in which drawings of a management area in which the image photographing unit 100 is installed are stored. Here, the drawing stored in the drawing DB is a 2D drawing or a 3D drawing of a management area. And the object information DB may store the object image as an enlarged image.

The DB constituting the image storage unit 200 requests a user to handle data through a database management system (DBMS), the DBMS handles the contents of a physical file, and includes both a file base form and a DB base form. In this case, the file base refers to a database consisting of only pure files excluding data logic.

According to a first embodiment, the 2D drawing or the 3D drawing may be pre-produced and stored in the drawing DB of the image storage unit 200.

According to a second embodiment, the administrator may generate a 3D drawing in a space in which the image photographing unit 100 is installed using a 3D scanner and store the 3D drawing in the drawing DB as it is or convert the 3D drawing into 2D and store the same in the drawing DB.

According to a third embodiment, the manager may generate a 3D drawing using the depth camera and the 3D drawing production program embedded in the image storage unit 200 and then store the 3D drawing in the drawing DB or convert the 3D drawing into 2D and store the same in the drawing DB.

The depth camera provides RGB color values and depth values to a 3D drawing production program of the image storage unit, and the 3D drawing production program generates 3D drawings in real time based on the RGB color value and depth value. In addition, the drawings generated in real time may be stored in the image storage unit 200, but may be used by loading only the memory provided in the image control system.

If necessary, the data generated by the depth camera can be immediately provided to the 3D drawing program for use in 3D drawing, or converted to polygon data using 3ds Max, Maya, Google Sketch, etc., and then provided to the 3D drawing program for use.

Meanwhile, the image storage unit 200 may further include a tracking information database DB in which the behavior pattern information of the criminal and the location information of the entrance and the window in the building are stored. In this case, since the movement path of the intruder may vary depending on the type of business establishment entering the building, the tracking information DB may further include business establishment information entering the building.

In addition, the image storage unit 200 may further include an adjustment information database DB in which adjustment information for adjusting an operation of the image photographing unit 100 is stored. The adjustment information DB stores close-up information on which the rotation angle and zooming ratio of the image photographing unit 100 are set according to the coordinate value of the monitoring area in which the image photographing unit 100 acquires the image information. Here, the zooming ratio may be adjusted according to the type of the object.

For example, since the size of the person and the vehicle are different from each other, when the zooming ratio is set based on the vehicle, when the object is recognized as a person, the zoom of the image photographing unit 100 is adjusted to be reduced.

When the above-described image storage unit 200 is not included in the object tracking system according to the present invention, the object extraction unit 300 may include a volatile memory for storing image information transmitted from the image photographing unit 100.

Referring to FIG. 1, the object tracking system according to the present invention includes an object extraction unit 300. The object extraction unit 300 analyzes image information provided from each image photographing unit 100 with an image recognition program, or analyzes image information stored in the image storage unit 200, or analyzes image information stored in a volatile memory by an image recognition program to generate object information to which the coordinates of the moving object and the photographing time are added.

To this end, the object extraction unit 300 may include a volatile storage in which image information transmitted from the image photographing unit 100 is stored and an image recognition program is stored.

And the object extraction unit 300 stores the generated object information in the image storage unit 200 or the volatile memory. To this end, the object extraction unit 300 may be connected to the image storage unit 200 through a communication network.

According to an embodiment, the object extraction unit 300 analyzes image information stored in the volatile memory by an image recognition program to extract an object image of a moving object, generates object information in which coordinates and photographing time are added to the object image, and stores the object information in the volatile memory.

In another embodiment, the object extraction unit 300 according to the present invention performs image recognition on the object image based on image information stored in the image storage unit 200 or the volatile memory without extracting the object image. More specifically, the object extraction unit 300 analyzes image information stored in the volatile memory by an image recognition program to generate a rectangular outline on the outside of the object along the edge of the moving object, extracts coordinates of each vertex of the outline, and stores the object information in the image storage unit 200 or the volatile memory.

The object extraction unit 300 may extract an object image formed only of an outer line of an object, or may extract an object image formed of an outer line of an object and an image within the outer line. In this case, when an object image including an image within an outline is extracted, a background check function or an access control function for a specific person may be provided using a facial recognition function later.

The object extraction unit 300 may analyze the aspect ratio of the outline surrounding the object from the image information to calculate the aspect ratio of the outline and add the aspect ratio to the object information. In this case, since the aspect ratio is changed when the object extends its arm, the arm portion may be excluded from the comparison, and since the aspect ratio is changed when the posture of the object is changed, such as sitting or lying down, the object extraction unit 300 may analyze the aspect ratio of the outer line surrounding the standing object.

The object extraction unit (300) may use an image recognition program installed in its own volatile memory, or an image recognition program installed in the image storage unit (200).

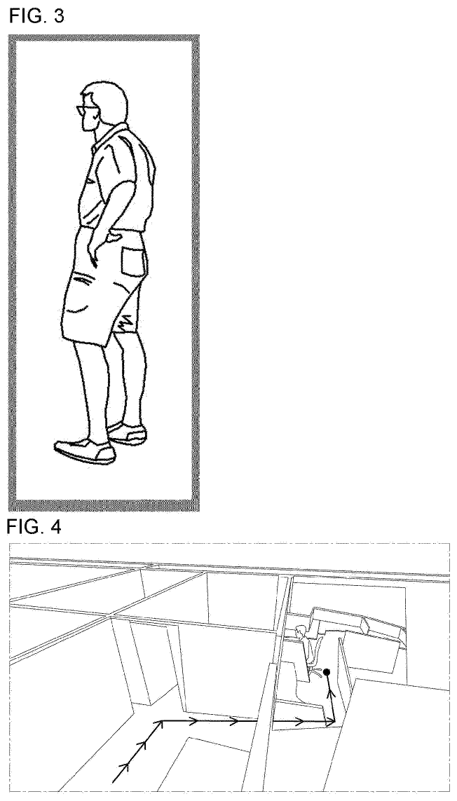

FIGS. 2 and 3 are embodiments of an outline photograph of an object displayed in an image output through an object tracking system according to the present invention. As shown in FIGS. 2 and 3, the object extraction unit 300 may extract an outline of an object from an object image, generate tracking image information in which the outline is merged in the image information, and store the image storage unit 200 or a volatile memory included therein. In this case, the outline of the object may be formed as an edge portion of the object image as shown in FIG. 2 or as a quadrangle surrounding the object image as shown in FIG. 3.

For example, the object extraction unit 300 may be configured to extract an object image of a moving object in a rectangular shape by analyzing image information stored in the image storage unit 200 or the volatile memory by an image recognition program. In this case, the rectangle may be formed by the outline described above.

In addition, a portion of the square surrounding the object in the object image excluding the object may be composed of achromatic colors such as black and white. In this way, when the rectangle surrounding the object is an achromatic color, only the pixel of the region in which movement is captured has a color value, and thus the color distribution of the pixels for each of R, G, and B may be analyzed. In this case, the analysis of the color distribution chart may be performed through analysis of a dominant color or a dominant hue.

In other words, when an object included in the object image is within a designated error range by comparing it with a color value of the object selected by the manager, it is determined as an object and the type thereof is classified.

More specifically, the object extractor 300 may classify the types of object images extracted from the image information through the image recognition program into any one of a person, a vehicle, a motorcycle, a bicycle, and an animal. In addition, the object extraction unit 300 may generate object information further including object type information in which the object type is designated. In addition, the object extraction unit 300 may classify the types of tracking targets by applying deep learning technology to improve the accuracy of classification.

In addition, the object extraction unit 300 may generate an object information list in which object information is classified according to an object type, coordinates, or a photographing time, and may store the object information list in the image storage unit 200 or the volatile memory. This is to enable the manager to select an object to be checked for each type even if the image information of the monitoring area is not directly viewed.

The object extractor 300 may use a server having an image recognition program installed therein or a PC having an image recognition program installed therein.

In a specific aspect, the object extraction unit 300 according to the present invention analyzes image information received from the image photographing unit 100, detects an object entering the monitoring area, and designates the object as a target. The object extraction unit 300 analyzes a real-time coordinate value of an object designated as a target, and extracts close-up information equivalent to the coordinate value from the image storage unit 200 or the volatile memory.

More specifically, the object extraction unit 300 analyzes the image information to detect whether there is an object entering the monitoring area from the outside. In addition, the object extraction unit 300 designates and tracks an object entering the monitoring area as a target, extracts a feature of the object, temporarily stores the feature in a buffer or a register, and analyzes a coordinate value of the object through image information.

If necessary, the object extraction unit 300 analyzes the image information to determine whether the object corresponds to a tracking target. For example, if an object designated as a target suddenly rotates or appears again by another object, it compares the features of any first object located at the same or similar coordinate value as the existing object to determine whether the first object being tracked corresponds to the object to be tracked. If it is determined that the first object is different from the object designated as the tracking object, the second object closest to the coordinates at which the existing object is located is detected to determine whether the second object corresponds to the object to be tracked.

In addition, the object extraction unit 300 tracks the motion of the object. Since the object may be moved, the object extraction unit 300 tracks the position movement of the object and analyzes the coordinate value of the object in real time.

In addition, when the object is out of the monitoring area or the object is stopped without moving for a set time, the object extraction unit 300 extracts the close-up information of the newly detected object from the image storage unit 200 or the volatile memory after terminating extraction of the object. In this case, the object extraction unit 300 analyzes the image information generated by the image photographing unit 100 during the rotation process to the initial position and designates the object initially detected through the image information as a new target for generating an enlarged image.

When the extraction of the close-up information on the object designated as the target is completed, the object extraction unit 300 generates a rotation signal of the image photographing unit 100 and provides the same to the image photographing unit 100.

And when the photographing time of the enlarged image is input through a user interface to be described later, the object extraction unit 300 generates a rotation signal for controlling the image photographing unit 100 to rotate to an initial position after photographing the enlarged image for a set time.

Meanwhile, the object extraction unit 300 may include an object recognition data table and a surrounding object data table to distinguish an object from a surrounding object using image information.

The object recognition data table is configured by storing setting data for shape detection, biometric recognition, and coordinate recognition of an object in order to distinguish objects. In this case, the configuration data for shape detection is configuration data for recognizing a shape of a complex figure, particularly, a license plate of a vehicle, or the like, a vehicle or a motorcycle shape to which movement occurs. In addition, the setting data for biometric recognition is setting data for recognizing eyes, nose, and mouth based on the characteristics of the human body, especially the human face.

The surrounding object data table is configured by storing setting data for geographic information, shape detection, and coordinate recognition of surrounding objects in order to distinguish surrounding objects by the object extraction unit 300. In this case, the setting data for geographic information of the surrounding objects is setting data for terrain, features, etc. of a preset area, and the setting data for shape sensing corresponds to the setting data for shape sensing of the object recognition data table described above.

In particular, the setting data for coordinate recognition to be commonly recognized may be linked with virtual spatial coordinates or geographic information through image information generated by the image photographing unit 100 to grasp points of objects and surrounding objects, particularly moving positions.

In addition, the object extraction unit 300 extracts predetermined close-up information according to the coordinate value of the object entering the monitoring area so that the enlarged image of the object may be photographed. Here, the close-up information is a control signal designated to control the fan, tilt, and zoom of the image photographing unit 100 to a preset value according to the coordinate value.

In addition, the object extraction unit 300 may analyze the image information to designate a type of the object, and may change the close-up information so that the zoom-in position of the image photographing unit 100 varies according to the type of the object. For example, when the appearance of the object is analyzed as a person, the object extraction unit 300 changes the close-up information so that the face is zoomed in close-up from the entire body of the person. And when the appearance of the object is analyzed as a vehicle through image information, the object extraction unit 300 changes the close-up information so as to photograph an enlarged image of the license plate of the vehicle.

In this way, the object extraction unit 300 may modify the close-up information so that the enlarged image is photographed with respect to elements (face, license plate) most suitable for tracking the object later.

If necessary, when the object is read as being out of the monitoring area by analyzing the image information, the object extraction unit 300 may delete the image information of the object when the type of the object does not correspond to a predetermined type. This is to minimize the capacity of image information stored in the image storage unit 200 by deleting image information on the object when an object unnecessary for security confirmation such as an animal enters the monitoring area.

In addition, the object extraction unit 300 may be configured to extract close-up information of the first object until the first object leaves the monitoring area even if the presence of the second object entering the monitoring area is detected while extracting close-up information of the first object designated as a target.

In addition, when a target change signal for an object other than a target among objects located in the monitoring area is input through the user interface, the object extraction unit 300 stops the extraction of close-up information of the target designated object and extracts close-up information of the new object. Accordingly, the image photographing unit 100 generates image information on an enlarged image of an object designated as a target, and generates image information on an enlarged image of a new object. In this way, the object for photographing the enlarged image may be selected by a manager through a user interface.

The object extractor 300 may use a server having an image recognition program installed therein or a PC having an image recognition program installed therein.

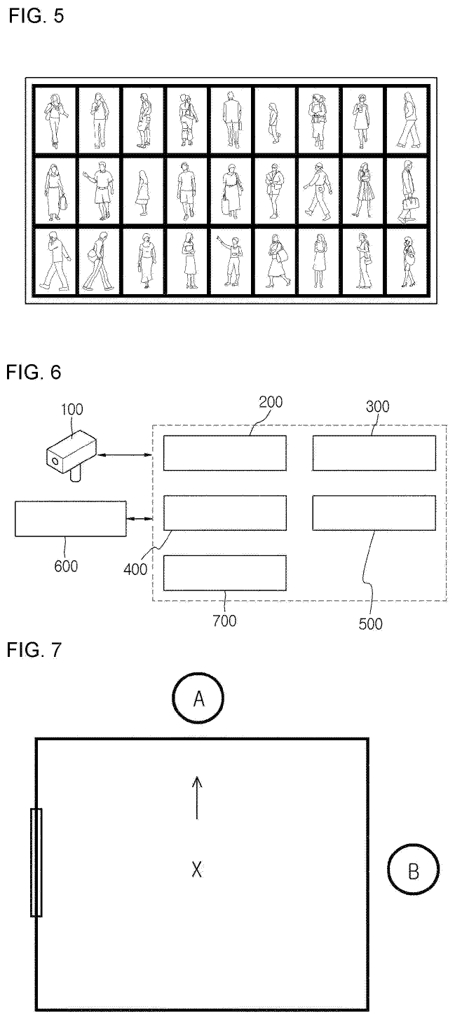

FIGS. 4 and 5 are exemplary diagrams illustrating an image of an object output through a tracking system according to the present invention.

Referring to FIG. 1, the object tracking system according to the present invention may further include an image output unit 500.

The image output unit 500 outputs image information provided from the image photographing unit 100 or image information stored in the image storage unit 200 to be checked by a manager, and to this end, is connected to the image photographing unit 100 through a communication network or an object extraction unit 300.

If necessary, when the object tracking unit 400 generates tracking image information in which an outline is merged with the image information, the image output unit 500 may output the tracking image information as an image at the request of a manager.

The image output unit 500 may use any one of a single monitor, a multi-monitor, a virtual reality device, and an augmented reality device.

In addition, the image output unit 500 may independently output image information provided from each image photographing unit 100 as shown in FIG. 4, and may output the entire image information overlapped with each image photographing unit 100 on the 2D or 3D drawings of the management area as shown in FIG. 5. In this case, when the management area is a specific building, the 2D drawing or the 3D drawing is a 2D drawing or a 3D drawing inside the building.

In addition, as illustrated in FIG. 5, the image output unit 500 may output a 2D drawing or a 3D drawing of a management area in which a movement path of an object or an expected escape path is displayed according to a request of a manager.

The object tracking system according to the present invention may further include a user interface (not shown).

The user interface generates a selection signal of an object by selecting an object existing in the image output from the image output unit 500, and a mouse, a keyboard, or a touch pad may be used.

Here, the selection of the object to be tracked is designated by the manager, and may be set by the manager through the user interface. Specifically, when the image output unit 500 outputs image information as an image, the manager may select an inner region of an outline in which an actual image of an object exists in the image or an object included in the object information list as an object to be tracked.

In addition, the user interface may provide a selection signal of the generated object to the object tracking unit 400 connected through a communication network.

In addition, the user interface may receive a target change signal of the second object from the manager and provide the target change signal of the second object located in the monitoring area instead of the first object to the object extraction unit 300 before any first object leaves the monitoring area

Referring to FIG. 1, the object tracking system according to the present invention includes an object tracking unit 400.

The object tracking unit 400 tracks the movement path of the object entering the monitoring area, compares and analyzes each object image to extract object information including the same object image from the volatile memory of the image storage unit 200 and analyzes the coordinates and photographing time of the object.

The object tracking unit 400 analyzes a color distribution chart of a first object image of an object selected from among objects stored in the image storage unit 200 and selects object information including a second object within a predetermined numerical range from the object information stored in the image storage unit. In this case, it is preferable that the predetermined numerical range is 50% to 100%. When such a accordance degree is set to less than 50%, a problem may occur in which different objects are designated as the same object.

According to a first embodiment, the object tracking unit 400 according to the present invention extracts object information including an object image of a second object having the highest accordance degree with the first object for each monitoring area of the same candidate group from the volatile memory of the image storage unit 200 or the object extraction unit 300.

According to a second embodiment, the object tracking unit 400 according to the present invention extracts object information including a second object image of the second object having the highest aspect ratio from the volatile memory of the image storage unit 200 or the object extraction unit 300.

The color distribution chart may be any one selected from the group consisting of a color distribution chart of each pixel of an object image, a color distribution chart for each line of the object image, an average color distribution chart of the entire object image, and a color distribution chart of each region of the divided object image.

Specifically, the color distribution for each pixel of the object image is determined by comparing RGB or Hue values of each pixel of the object image, and the color distribution for each line of the object image is determined by comparing RGB or Hue values for dominant colors. And the average color distribution across the object image is determined by comparing RGB or Hue values for the dominant color across the object image, and the color distribution of each region of the partitioned object image is determined by dividing the object image by up/down or up/down/down/down.

The object tracking unit 400 may designate an object image selected through comparison analysis of a first object and an image selected by a manager as the same candidate group, analyze coordinates of vertices of the object image, 3D drawings stored in the image storage unit, and analyze a change in position coordinates and photographing time of the object.

In a third embodiment, the object tracking unit 400 according to the present invention may extract object information including an object image having an increase/decrease rate of 0 to 10% in the same candidate group from volatile memory of the image storage unit 200 or the object extraction unit 300, and analyze coordinates and photographing time of the extracted object information.

According to a fourth embodiment, the object tracking unit 400 may detect a movement speed of the first object by analyzing a change in position coordinates and a photographing time on the image information extracted from the object image of the same candidate group, calculate a movement distance for each time.

Meanwhile, the object tracking unit 400 according to the present invention may be configured to track a movement path of an object selected by a manager among images output through the image output unit 500, analyze the movement path of the object selected by the manager, and display the movement path in the drawing.

Specifically, the object tracking unit 400 extracts object information including an object image of the selected object based on the object image of the selected object from the volatile memory of the image storage unit 200 or the object extraction unit 300. And the object tracking unit 400 analyzes the coordinates and photographing time of object information extracted from the volatile memory of the image storage unit 200 or the object extraction unit 300 and displays the movement path of the object on the drawing stored in the image storage unit 200.

To this end, the object tracking unit 400 extracts object information including the same object image as the selected object image, analyzes coordinates and photographing time added to the object information, and displays the movement path of the object on the drawing selected by the manager. The object tracking program may be installed in a memory included in the object tracking unit 400 or may be installed in the image storage unit 200.

More specifically, the object tracking unit 400 analyzes the coordinates and photographing time of the object information to generate a movement path image of the object to which each coordinate is connected, merges the movement path image into a 2D drawing or 3D selected by the manager, and outputs the drawing displayed through the image output unit 500.

In this case, the method of extracting object information including the same object image as the object image selected by the manager by the object tracking unit 400 may use the following method alone or in combination.

First, object information including the same face as the object image is extracted by comparing only the face through the face recognition function of the object tracking program.

Second, by comparing distributions of pixels R, G, and B in the inner area of the outline, object information including the same object image is extracted by determining the same object within a specified error range.

Third, object information including the same object image and the same object image is extracted by comparing the size of the outline of the image photographed at the same magnification and determining it as the same object if it is within a specified error range.

The object tracking unit 400 may assign an outline of the same color to an object determined to be the same as an object selected by the manager so that the manager may easily distinguish the object to be tracked from the image.

To this end, when the selection signal of the object included in the image of the tracking image information is received, the object tracking unit 400 searches for and extracts object information including an outline of the same size based on the outline of the selected object. In addition, the object tracking unit 400 imparts a first color to the outer line of the object matched with the selection signal of the object, and imparts a first color to the outer line of the same object among tracking image information stored in the volatile memory of the image storage unit 200 or the object extraction unit 300.

When the object disappears from the image on which the selection signal of the object is received, the object tracking unit 400 may detect a prediction path in which the selected object is movable using the drawings stored in the image storage unit 200, and may preferentially compare the object image extracted from the image information.

In a specific aspect, the object tracking unit 400 according to the present invention may have different lighting according to each monitoring area or a body ratio according to an angle of the image capturing unit. Therefore, in the process of learning the AI neural network model using deep learning, the AI neural network model is first learned with image information of the first image photographing unit stored in the image storage unit. Thereafter, a so-called transfer learning technique of repeating a process of learning a model determining whether the model is the same using image information of the second image capturing unit stored in the image storage unit may be applied.

When applying the transfer learning technique, the accuracy can be improved by first learning a classifying neural network model A for classifying objects (people, dogs, cats, cars, etc.) to obtain the model with the highest recognition rate for people, and then using it to learn neural network model B for determining the same person.

The deep learning may be trained to classify people, cars, animals, etc. from the image information acquired by the image photographing unit 100, to find only people, or to find the same object among the extracted object images. In addition, learning to find a person in the image information uses object images of various people such as a and b, and learning to find the same object uses various image information, but the accuracy of deep learning results can be determined only when a specific object appearing in the image photographing unit a is included among various images.

The object tracking system according to the present invention may further include a controller (not shown).

The control unit controls the operation of the image photographing unit 100 according to the close-up information extracted from the object extraction unit 300, receives the image information from the image photographing unit 100 and stores the image in a volatile memory of the image storage unit 200 or the object extraction unit 300, and an object tracking unit 400.

In more detail, the control unit generates a control signal based on the close-up information provided by the object extraction unit 300 and provides the control signal to the image photographing unit 100 through a communication network to capture an enlarged image of an object moving inside the monitoring area. And when image information of an object designated as a target is transmitted from the image photographing unit 100, the control unit stores the image information in a volatile memory of the image storage unit 200 or the object extraction unit 300.

In addition, when a target change signal is input through a user interface, the control unit provides the object extraction unit 300, and when the selection signal of the object is input, the object tracking unit 400 provides the target change signal.

In addition, the control unit controls the image photographing unit 100 so that the image photographing unit 100 rotates to an initial position when a rotation signal is transmitted from the object extracting unit 300.

FIG. 6 is a block diagram illustrating a tracking system according to another embodiment of the present invention.

Referring to FIG. 6, the object tracking system according to the present invention may further include a user terminal 600 and an augmented reality unit 700.

The user terminal 600 is equipped with an augmented reality app that outputs an image of a neighboring space through a screen so that a user may check an image of a neighboring space whose view is blocked even when the view is blocked by the structure, and is connected to the augmented reality unit 700 through a communication network.

Specifically, when an image of a structure adjacent to a monitoring area is collected from a camera module provided in the user terminal 600, the augmented reality app generates structure image information to which the location information of the structure adjacent to the monitoring area is added. The augmented reality app transmits the structure location information to the outside, for example, the augmented reality unit 700 through a communication network, receives image information of a monitoring area adjacent to the structure location information, and outputs the received image information overlapping with the structure image information.

If necessary, the augmented reality app may be configured to adjust the transparency of the structure image information overlapping the image information of the monitoring area according to a control signal input from the user. For example, when a user inputs the transparency of the structure image information to the augmented reality app of the user terminal 600 as 100%, the augmented reality app controls the transparency of the structure image information so that only the image information of the monitoring area is output. And when the user inputs 50% transparency of the structure image information, the augmented reality app controls the transparency of the structure image information so that the structure image information is translucent and output together with the image information of the monitoring area.

The augmented reality unit 700 provides an image of a neighboring space in which a user's field of view is blocked to the user terminal 600, and is connected to the user terminal 600 through a communication network.

More specifically, the augmented reality unit 700 searches for first monitoring area location information matched with the structure location information transmitted from the user terminal 600, detects image information of the monitoring area to which the first monitoring area location information is added, and transmits the detected image information to the user terminal 600 through a communication network.

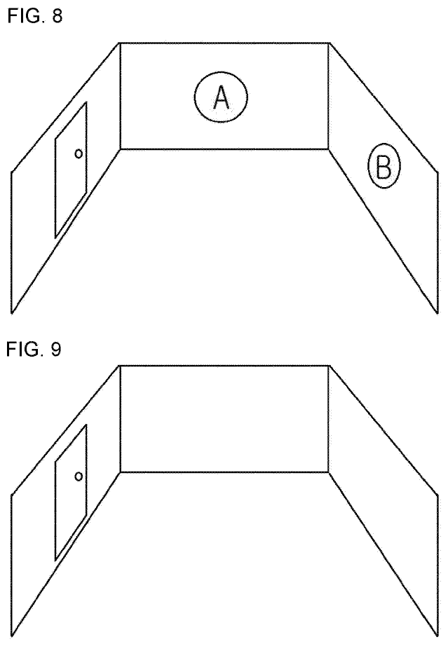

FIG. 7 is a plan view showing a structure in which a user terminal according to the present invention is located, and FIG. 8 and FIG. 9 are screens showing a screen output through the user terminal according to the present invention.

Referring to FIGS. 7 to 9, when the observer X having the user terminal 600 according to the present invention faces the wall in the direction of the arrow, the observer X is located on the closed space (room), and thus the object A and the object B located beyond the wall of the closed space may not be identified.

However, when the observer X transmits the location information of the first structure on the wall to the augmented reality unit 700 through the communication network, the augmented reality unit 700 searches for location information of the first structure matched with the location information of the first structure transmitted from the user terminal 600, detects image storage unit, and transmits the object A1 image. Subsequently, the user terminal 600 owned by the observer X receives the object A and the object B, and outputs the object image overlapping the structure image information.

In this invention, since the augmented reality unit 700 may check the positions and sizes of the object A and the object B located in the monitoring area adjacent to the structure position information, the positions of the objects A and B relative to the observer X may be known, and thus, object images of the objects A and B matched to the wall surface generating the structure position information may be shown to the observer X.

In this case, when the observer X inputs 50% of the transparency of the structure image information through the user terminal 600, the wall surface becomes translucent as shown in FIG. 8, and the images of objects A and B are output together with the image of the wall. And when the observer X inputs the transparency of the structure image information as 0% through the user terminal 600, the wall surface becomes opaque as shown in FIG. 9, and the images of objects A and B cannot be viewed.

The object tracking system according to the present invention may further include an object behavior pattern unit (not shown).

The object behavior prediction unit generates escape path information of an object by analyzing object information including the same object image extracted by the object tracking unit 400, criminal behavior pattern information, and location information of a building by machine learning or data mining algorithm.

If necessary, the object behavior prediction unit may generate escape route information of an object by analyzing object information, behavior pattern information of a criminal, location information of an entrance door and a window in a building, and workplace information in a machine learning or data mining algorithm.

The object behavior prediction unit automatically finds a plurality of object information including the same object image and analyzes the escape path of the object by finding statistical rules or patterns.

Specifically, object behavior predictors can escape by classification to infer classification and classification through a specific definition of a given group, clustering to find clusters that share specific characteristics, associations defining relationships between events, sequencing over a specific period, and predicting the future.

Although the preferred embodiments of the present disclosure have been described above, those skilled in the art will understand that the present disclosure may be modified and changed in various ways without departing from the spirit and scope of the present disclosure written in the appended claims.

1. A tracking system capable of tracking a movement path of an object, the system comprising:
a plurality of image photographing units for acquiring image information by photographing a surveillance area;
an object extraction unit for generating object information, to which coordinates and photographing time of a moving object are added, by analyzing image information transmitted from the image photographing units using an image recognition program; and
an object tracking unit for selecting object information including the same object image by comparing and analyzing images of each object through the object information, and tracking a movement path of the object by analyzing coordinates and photographing time of the selected object information.

2. The system according to claim 1, wherein the object extraction unit generates a rectangular outline outside the object along the edge of the moving object by analyzing the image information using an image recognition program, extracts coordinates of each vertex of the outline, and generates object information to which coordinates and photographing time of the vertices of the outline are added.

3. The system according to claim 1, wherein the object tracking unit analyzes a color distribution chart of a first object image of an object selected by a manager among objects of which the object information is stored, selects, among the object information, object information including a second object having an accordance degree of 50 to 100% with respect to the first object as the same candidate group, and extracts object information including a second object image of a second object having the highest accordance degree with respect to the first object for each surveillance area.

4. The system according to claim 3, wherein the color distribution chart is a dominant color distribution chart or a dominant hue distribution chart.

5. The system according to claim 3, wherein the color distribution chart is any one selected from a group configured of a color distribution chart of each pixel of an object image, a color distribution chart of each line of an object image, an average color distribution chart of an entire object image, and a color distribution chart of each area of a partitioned object image.

6. The system according to claim 1, wherein the object extraction unit generates a rectangular outline outside the object along the edge of the moving object by analyzing the image information using an image recognition program, calculates an aspect ratio by analyzing horizontal and vertical sizes of the outline, and adds the aspect ratio to the object information, and the object tracking unit analyzes a color distribution chart of a first object image of an object selected by a manager among objects of which the object information is stored, selects, among the object information, object information including a second object having an accordance degree of 50 to 100% with respect to the first object as the same candidate group, and extracts object information including a second object image of a second object having the highest aspect ratio with respect to the first object for each surveillance area.

7. The system according to claim 6, wherein the object extraction unit generates the aspect ratio by analyzing a horizontal to vertical ratio of an outline surrounding a standing object.

8. The system according to claim 1, wherein the object extraction unit is configured to include a volatile memory for storing the image information transmitted from each image photographing unit, and storing the object information.

9. The system according to claim 1, further comprising an image storage unit for storing the image information transmitted from each image photographing unit.

10. The system according to claim 9, wherein the object extraction unit generates object information, to which coordinates and photographing time of a moving object are added, by analyzing the image information stored in the image storage unit using an image recognition program, and stores the object information in the image storage unit.

11. The system according to claim 9, wherein the object extraction unit extracts an object image of the moving object by analyzing the image information stored in the image storage unit using an image recognition program, generates object information of the object image to which coordinates and photographing time are added, and stores the object information in the image storage unit.

12. The system according to claim 9, wherein the image storage unit stores a 3D drawing of a space in which the plurality of image photographing units is installed, and the object extraction unit generates a rectangular outline outside the object along the edge of the moving object by analyzing the image information stored in the image storage unit using an image recognition program, extracts an object image inside the outline, extracts coordinates of each vertex of the outline, and generates object information to which coordinates and the photographing time are added, and the object tracking unit designates a first object selected by a manager and an object image selected through comparison and analysis of an image as the same candidate group, detects position coordinates of the object image on the 3D drawing by analyzing the coordinates of the vertices of the object image of the same candidate group and the 3D drawing stored in the image storage unit, and detects a movement speed of the object by analyzing change in the position coordinates and the photographing time of the object in the image information from which the object image of the same candidate group is extracted.

13. The system according to claim 12, wherein the object tracking unit extracts object information including an object image, of which an increase/decrease rate of movement speed is 0 to 10%, detected among the same candidate group, from the image storage unit, and tracks a movement path of the object by analyzing coordinates and photographing time of the extracted object information.

14. The system according to claim 12, wherein the object tracking unit detects a movement speed of the first object by analyzing change in position coordinates and photographing time of the first object in the image information from which the first object image is extracted, calculates a distance that can be traveled per hour on the basis of the movement speed of the first object, extracts object information including a second object image located on the distance that can be traveled, among the object images of the same candidate group, from the image storage unit, and tracks a movement path of the object by analyzing coordinates and photographing time of the extracted object information.

15. A tracking system capable of tracking a movement path of an object, the system comprising:
a plurality of image photographing units for acquiring image information by photographing a surveillance area;
an image storage unit for storing image information transmitted from each image photographing unit, and storing a 2D or 3D drawing of a space in which the plurality of image photographing units is installed;
an object extraction unit for generating object information, to which coordinates and photographing time of a moving object are added, by analyzing the image information stored in the image storage unit using an image recognition program;
an image output unit for outputting image information provided from each image photographing unit as an image; and
an object tracking unit for extracting object information including the same object image from the image storage unit by analyzing an object image of an object selected as a selection signal of an object included in the image output through the image output unit is received, and displaying a movement path of the object on the drawing by analyzing coordinates and photographing time of the extracted object information.

16. The system according to claim 15, wherein when there is an omission section where a movement path of the object is omitted on the 2D or 3D drawing as the image photographing unit is not installed, the object tracking unit displays a virtual movement path between a first movement path and a second movement path adjacent to the omission section so that the first movement path and the second movement path may be connected to each other.

17. The system according to claim 15, wherein the object tracking unit generates a movement path image of an object to which every coordinates are connected by analyzing the coordinates and photographing time of the object information, and outputs a drawing on which the movement path image is displayed through the image output unit.

18. The system according to claim 15, wherein the object extraction unit extracts an outline of an object from the object image, generates image information for tracking, in which the outline is merged with the image information, and stores the image information in the image storage unit, and the object tracking unit assigns a first color to the outline of the object that matches the selection signal, and assigns the first color to an outline of an object the same as an object, among the image information for tracking, to which the first color is assigned.

19. The system according to claim 18, wherein the outline of the object is an edge portion of the object image or a rectangle surrounding the object image.

20. The system according to claim 15, wherein the object information further includes information on a type of an object designated as any one among a person, a car, a motorcycle, a bicycle, and an animal.

21. The system according to claim 15, wherein when an object disappears from an image including an object for which the selection signal is received, the object tracking unit detects a predicted path, along which the selected object may move, using the 2D or 3D drawing stored in the image storage unit, and generates object information by preferentially comparing an object image extracted from image information transmitted from an image photographing unit installed on the predicted path with an object image selected by a manager.

22. A tracking system capable of tracking a movement path of an object, the system comprising:
a plurality of image photographing units for acquiring image information, to which surveillance area location information is added, by photographing a surveillance area;
an object extraction unit for generating object information, to which coordinates and photographing time of a moving object are added, by analyzing the image information using an image recognition program;
an object tracking unit for selecting object information including the same object image by comparing and analyzing images of each object through the object information, and tracking a movement path of the object by analyzing coordinates and photographing time of the selected object information;
a user terminal including an augmented reality app installed therein, for generating structure image information, to which structure location information adjacent to the surveillance area location information is added, transmitting the structure location information to the outside through a communication network, receiving image information of a surveillance area adjacent to the structure location information, and outputting the image information so as to be overlapped with the structure image information; and
an augmented reality unit for searching for location information of a first surveillance area that matches the structure location information transmitted from the user terminal and detecting image information of a surveillance area to which the first surveillance area location information is added, and transmitting the detected image information to the user terminal through a communication network.

23. The system according to claim 22, further comprising:
an image storage unit for storing image information transmitted from each image photographing unit, and storing behavior pattern information of criminals and location information of entrance doors and windows in a building; and
an object behavior prediction unit for generating escape route information of an object by analyzing object information including the same object image extracted by the object tracking unit, the behavior pattern information of criminals, and the location information of entrance doors and windows in a building through a machine learning or data mining algorithm, and transmitting the escape route information to a user terminal located on an escape route of the object.

24. The system according to claim 22, wherein the augmented reality app is configured to adjust transparency of the structure image information overlapped with the image information of the surveillance area according to a control signal input from a user.
